(19) United States
(12) Patent Application Publication
(10) Pub. No.: US 2014/0130644 A1
(43) Pub. Date: May 15, 2014

(54) SYSTEM AND METHOD FOR MAKING SCREEN PROTECTORS

(71) Applicants: Marvin A. Ashaka, Commerce Township, MI (US); Bahaa B. Najem, Commerce Township, MI (US)

(72) Inventors: Marvin A. Ashaka, Commerce Township, MI (US); Bahaa B. Najem, Commerce Township, MI (US)

(21) Appl. No.: 14/077,947

(22) Filed: Nov. 12, 2013

Related U.S. Application Data
(60) Provisional application No. 61/725,777, filed on Nov. 13, 2012.

(51) Int. Cl. B26D 5/00

(52) U.S. Cl. CPC B26D 5/005
USPC 83/13; 83/76.1

(57) ABSTRACT

The present invention provides a system and method for creating screen protectors for electronic devices where the screen protectors may be formed from stock screen protector material to fit any of a multitude of differently sized, shaped and/or configured screens for distinct portable electronic devices. The system includes screen protector material, a cutting element, a control unit and an interface. The interface enables a user to actuate the control unit by selecting an electronic device from one of the supported devices. The system then cuts a screen protector to fit the selected device allowing a user to create new screen protectors as needed or required.

### CROSS-REFERENCE TO RELATED APPLICATION

The present application claims priority to U.S. provisional patent application Ser. No. 61/725,777, filed on Nov. 13, 2012, the disclosure of which is hereby incorporated herein by reference in its entirety.

### BACKGROUND OF THE INVENTION

The present invention is directed to an apparatus and method for making screen protectors, in particular for making screen protectors for touchscreen electronic devices.

Electronic devices include screens that are used to enable users to interface with the devices, including touchscreens on devices such as smartphones, computer tablets, and the like that are physically contacted by users. These screens are susceptible to damage such as by scratching. Even devices having screens made from specialty high-strength materials can be broken, scratched or damaged under certain circumstances. Accordingly, it is known to apply screen protectors to the screens in order to prevent the actual screen from being scratched or damaged, or to protect against oil from a user's skin, paint, or other materials that may contact the device's screen, where the screen protector is replaceable. Due to the many different types of portable electronic devices, numerous screen protector sizes, shapes and styles must be retained, such as by retailers.

### SUMMARY OF THE INVENTION

The present invention provides systems and methods for creating screen protectors for electronic devices, where the screen protectors may be formed from stock screen protector material to create a specific screen protector as needed or required.

According to an aspect of the present invention, a system for creating screen protectors for electronic devices comprises screen protector material, a cutting element, a control unit and an interface, with the control unit being programmed with a plurality of programs or profiles operable to control the cutting of the screen protector material to form a screen protector of a desired shape associated with an electronic device. The interface being operatively connected to the control unit and enabling a user to actuate the control unit to form a user selected screen protector. The screen protector material may be in the form of a sheet.

According to another aspect of the present invention, an apparatus for creating screen protectors for electronic devices comprises a housing, a cutting element, a control unit and an interface. The control unit is programmed with a plurality of programs or profiles to control the cutting of a screen protector material to form a screen protector of a desired shape, with the interface being operatively connected to the control unit and enabling a user to actuate the control unit to form a user selected screen protector.

In yet another aspect of the present invention, a screen protector kiosk comprises a housing, screen protector material, a cutting element, a control unit and an interface. The screen protector material, cutting element and said control unit are retained within the housing, and the interface is mounted to the housing. The interface is operatively connected to the control unit and enables a user to actuate the control unit to form a user selected screen protector, where the control unit is programmed with a plurality of programs or profiles, each of which is operable to control the cutting of the screen protector material by the cutting element to form a screen protector of a desired shape associated with an electronic device. The kiosk may include a payment control system for receiving payment for a screen protector.

Still further, a method of making a screen protector in accordance with an aspect of the invention comprises providing screen protector material, a cutting element, a control unit, and an interface, with the control unit being programmed with a plurality of programs or profiles that are operable to control the cutting of the screen protector material to form a screen protector of a desired shape associated with an electronic device. The interface is operatively connected to the control unit and enables a user to actuate the control unit.

The present invention provides a convenient and cost effective system and method of producing customized screen protectors, such as for electronic devices including smartphones, computer tablets, and the like, thereby eliminating the need to stock multiple screen protectors for the significant number of different electronic devices that are available, and continue to evolve. This avoids difficulties associated with both running out of a particular screen protector as well as carrying obsolete inventory. Additionally, the present invention provides an interface that is intuitive and easy to use, allowing consumers to create their own screen protector.

These and other objects, advantages, purposes and features of this invention will become apparent upon review of the following specification in conjunction with the drawings.

### BRIEF DESCRIPTION OF THE DRAWINGS

FIG. 1 discloses an apparatus for making screen protectors in accordance with an embodiment of the present invention;

FIG. 2 discloses a cutting element of the apparatus of FIG. 1 cutting a screen protector sheet;

FIG. 3 is a schematic representation of a program for use with the apparatus of FIG.

1 to create screen protectors; and

FIG. 4 is discloses an alternative embodiment of an apparatus for making screen protectors configured as a kiosk in accordance with the present invention.

### DESCRIPTION OF THE PREFERRED EMBODIMENTS

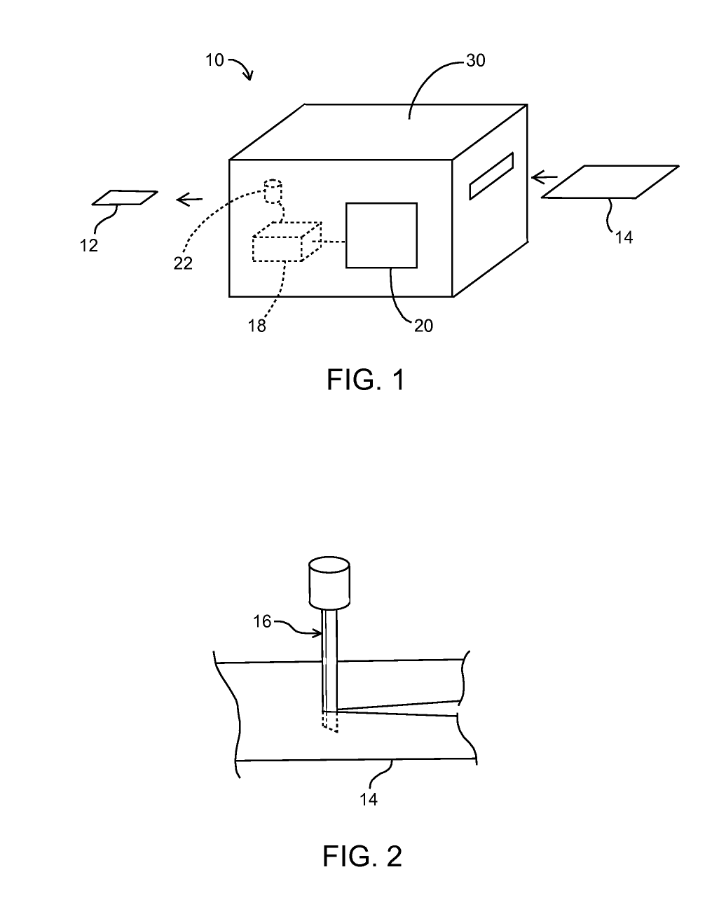

The present invention will now be described with reference to the accompanying figures, wherein the numbered elements in the following written description correspond to like-numbered elements in the figures. FIG. 1 discloses apparatus 10 used to make a customized screen protector 12 from screen protector material or blank 14, where apparatus 10 includes a cutting element 16 (FIG. 2) that is used to trim material 14 to a desired size to form screen protector 12. Apparatus 10 includes a controller or control unit 18 that is programmed and operable to route cutting element 16 to create screen protector 12 that is shaped or configured to fit the screen of a particular portable electronic device. Control unit 18 includes multiple programs or profiles whereby apparatus 10 may be selectively used to form screen protectors 12 for any of a multitude of differently sized, shaped and/or configured screens for distinct portable electronic devices.

Referring again to FIG. 1, apparatus 10 further includes an operator interface 20 and one or more drives or motors 22. Interface 20, which may be a touchscreen, keypad, or other interactive interface, is operatively connected with control unit 18 and enables a user to select a particular screen protector to be formed by apparatus 10, as described more below. Drive 22 is also operatively connected with control unit 18 and is operable to drive cutting element 16 to form a desired pattern or shape for forming screen protector 12.

In the illustrated embodiment screen protector material 14 is formed as a sheet that is inserted into apparatus 10. Material 14 may be manually fed into apparatus 10, or may be retained on a tray or the like and drawn into apparatus 10. Material 14 may include an adhesive or mastic on one side to promote adhesion to the screen of the electronic device to which screen protector 12 is to be applied. Moreover, material 14 may comprise a multilayered film material, such as including a layer that is peeled off to expose the mastic or adhesive of the material 14 prior to applying to a screen of an electronic device. Alternatively, material for forming screen protector may be retained on a roll that is fed into the internal cutting area or region of apparatus 10. As is well understood, material 14 is see through to enable a user to view the screen of their electronic device through the material 14.

Cutting element 16 is disclosed as a moveable blade that is routed through material 14 held within apparatus 10 to form a desired screen protector 12, where cutting element 16 is moved by drive 22. Material 14 may be retained in a stationary manner within apparatus 10 during the cutting operation, or alternatively may be moved simultaneously with movement of cutting element 16 to obtain the desired shape. For example, cutting element 16 may be moved in two axes while material 14 is held stationary or simultaneously moved during cutting. Alternatively, cutting element 16 may be moved in a single axis while material 14 is moved during cutting. Apparatus 10 may include various rollers and grip mechanisms for holding and moving material 14 through apparatus 10, as well as supports and guides for cutting element 16. Still further, alternative cutting elements may be employed relative to that shown in FIG. 2. For example, a straight edge device, hot wire, laser, or the like. It should be appreciated that cutting element 16 may be operatively connected with and driven by drive 22 in a number of ways, including via direct or indirect connections or linkages, in order to form or define an outer profile or perimeter of a screen protector 12. It should be understood that screen protectors may be formed to be of varying length and width, as well as have variously formed edges, such as rounded corners or other cutouts, based on the particular type of electronic device to which the desired screen protector is to be applied.

As previously noted, control unit 18 is programmed to operate apparatus 10 to form any of a variety of differently sized and shaped screen protectors 12 as needed for a specific electronic device. Accordingly, control unit 18 may include multiple different programs, each of which is associated with a specific screen protector 12, such as based on make and model for a particular electronic device. Such program would relate to the length, width and outer perimeter geometry of the desired screen protector shape. Alternatively, control unit 18 may have access to a memory or a database loaded with profiles for each of the various electronic devices, each electronic device profile containing information on the length, width and outer perimeter geometry for the desired screen protector shape for a particular electronic device. Still further, control unit 18 may alternatively or additionally be operable to receive input commands regarding the size and shape of a desired screen protector such as, for example, regarding a length and width to which the screen protector is to be made.

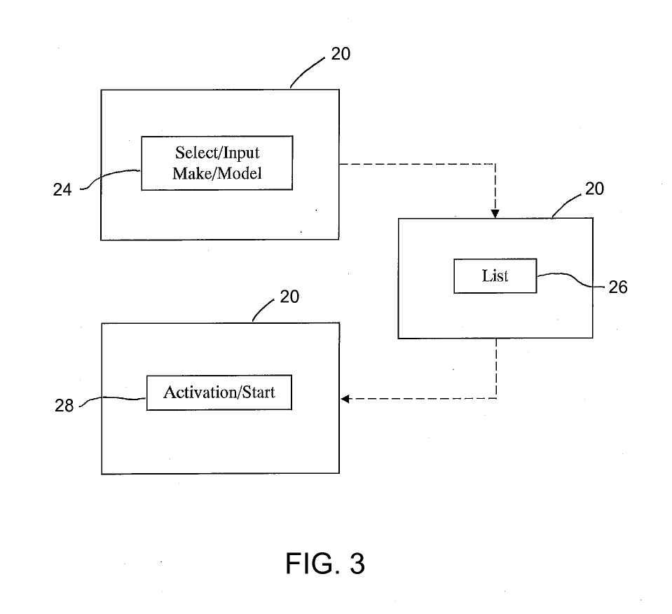

Referring now to FIG. 3, interface 20 is schematically represented disclosing the user selectable programming for creation of a particular screen protector 12. As shown, an initial step 24 involves a user initiating operations by selecting or inputting a particular make and model of electronic device, or selecting or inputting a particular size or profile, for which a screen protector is desired. Initiation step 24 may involve typing a make and model into interface 20, such as by a keypad or touchscreen. Alternatively, a list or menu 26 of available screen protectors for particular electronic devices may be provided for selection by a user. List 26 may comprise a series of screens or selectable choices provided to user. For example, an initial choice may be based on the make of the electronic device for which a screen protector is desired and, upon entry of this information to control unit 18, the available models associated with the entered make may be presented for selection by the user of apparatus 10. Alternatively, a selection may be based on size, such as by length and width, or selectable to set a desired length or width. Upon completion of step 24, operations for creation of screen protector 12 may be commenced at activation step 28, which may comprise a confirmation button that is activated by a user, or may automatically occur upon finalization of entry of the desired screen protector.

As noted, control unit 18 of apparatus 10 may be programmable to retain programs or profiles for constructing screen protectors for a multitude of different types of electronic devices, with each program or profile being based on specified dimensions for a particular screen protector. Apparatus 10 may include one or more ports, such as USB connections, Ethernet connections, or the like, to enable control unit 18 to be reprogrammed, such as to download additional programs or profiles for alternative electronic devices.

In the illustrated embodiment, apparatus 10 includes a housing 30 within which control unit 18 is mounted and to which interface 20 is connected. Alternatively, however, an external control unit, such as a computer or the like, may be utilized. For example, a computer may be connected via a wired or wireless connection to an apparatus housing one or more drives and a cutting element. In such an embodiment the computer may be utilized both as the control unit and the interface for selecting and initiating operation to create a screen protector.

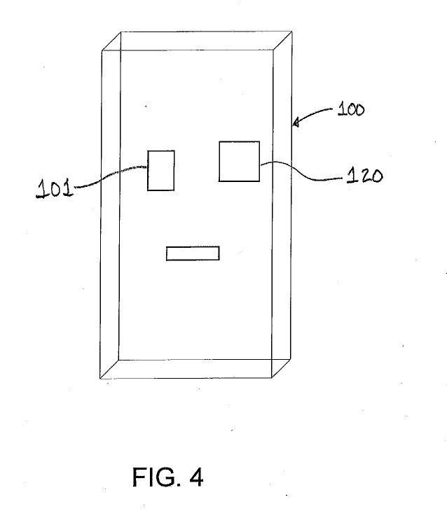

Apparatus 10 may be used in a retail facility, such as at a retailer of electronic devices. In another embodiment, apparatus 10 may be configured with an alternative housing 30 in the manner of a vending machine or kiosk, such as kiosk 100 illustrated in FIG. 4. Such an apparatus 100 includes an interface 120 and may further include a conventional payment structure 101 for accepting payment from a purchaser, such as by way of a credit card or depositing of coins and/or bills into the apparatus. Upon payment of the required fee, a purchaser may then proceed with the above outlined steps for obtaining a desired screen protector 12. Such a vending machine or kiosk 100 type apparatus may be placed in malls, stores, theaters and the like to enable purchasers to obtain a new screen protector as needed.

Still further, apparatus 10 may be provided with alternative types of material 14 for creation of screen protector 12. For example, material 14 may be tinted or be configured for privacy viewing whereby information displayed on the subject electronic device is viewable when looking directly at the screen through the material, but is not viewable when viewed at an angle. Apparatus 10 may include trays or holders for retaining various types of material 14. In such embodiments, interface 20 may be further configured to enable selection by the user of the type of material 14 to be used for the screen protector 12, in addition to the noted selection of the type of electronic device for which the screen protector 12 is to be made. This may include, for example an additional step in the process of FIG. 3.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A system for creating screen protectors for electronic devices, said system comprising:
screen protector material configured for being applied to electronic devices;
a cutting element;
a control unit, said control unit being programmed and operable to control the cutting of said screen protector material by said cutting element to form a screen protector in one of a plurality of supported screen protector shapes associated with various electronic devices; and
an interface, said interface being operatively connected to said control unit and enabling a user to actuate said control unit to form a user selected screen protector.

2. The system of claim 1 wherein said screen protector material is in the form of a sheet.

3. The system of claim 1 wherein said cutting element comprises a blade.

4. The system of claim 1 wherein said one of a plurality of supported screen protector shapes is selected by a user based on the type of electronic device for which said screen protector is intended.

5. The system of claim 1 wherein said system includes at least one driver, said driver being operatively connected with said control unit and said cutting element whereby said driver moves said cutting element in response to said control unit based on a selected one of said plurality of supported screen protector shapes.

6. The system of claim 1 further including a housing.

7. The system of claim 6 wherein said control unit is mounted in said housing.

8. The system of claim 6 wherein said interface is connected with said housing.

9. The system of claim 6 wherein said housing is a kiosk.

10. The system of claim 9 wherein said screen protector material, said cutting element and said control unit are retained within said housing, and wherein said interface is mounted to said housing.

11. The system of claim 10 wherein said one of a plurality of supported screen protector shapes is selected by a user based on the type of electronic device for which said screen protector is intended.

12. The system of claim 11 further including a payment control system, said payment control system accepting payment by a user prior to forming a screen protector.

13. A screen protector making apparatus, said apparatus comprising:
a cutting element;
a control unit, said control unit being operable to control the cutting of a screen protector material by said cutting element to form a screen protector; and
an interface, said interface being operatively connected to said control unit and enabling a user to actuate said control unit to form a user selected screen protector.

14. The apparatus of claim 13 wherein said control unit is programmed to control the cutting of a screen protector material by said cutting element to form a screen protector in one of a plurality of supported screen protector shapes associated with various electronic devices.

15. The apparatus of claim 13 wherein said cutting element comprises a blade.

16. The apparatus of claim 13 wherein said apparatus includes at least one driver, said driver being operatively connected with said control unit and said cutting element whereby said driver moves said cutting element in response to said control unit based on a selected one of said plurality of supported screen protector shapes.

17. A method of producing a screen protector, said method comprising:
providing screen protector material;
providing a cutting element and a control unit, said control unit being programmed and operable to control the cutting of said screen protector material by said cutting element to form a screen protector of a desired shape associated with an electronic device;
providing an interface, said interface being operatively connected to said control unit and enabling a user to actuate said control unit to form a user selected screen protector; and
cutting said screen protector material to form a screen protector for an electronic device based on the user's actuation.

18. The method of claim 17 wherein said screen protector material is in the form of a sheet.

19. The method of claim 17 wherein said cutting element comprises a blade.

20. The method of claim 17 wherein said one of a plurality of supported screen protector shapes is selected by a user based on the type of electronic device for which said screen protector is intended.
